(19) United States
(12) Patent Application Publication
(10) Pub. No.: US 2024/0391538 A1
(43) Pub. Date: Nov. 28, 2024

(54) TRAILABLE VEHICLE AND METHOD OF MANUFACTURING THE SAME

(71) Applicant: SUNBASE PTY LTD, Ferntree Gully, VIC (AU)

(72) Inventor: Binwei Ben LIU, Dandenong South, Victoria (AU)

(73) Assignee: SUNBASE PTY LTD, Ferntree Gully, VIC (AU)

(21) Appl. No.: 18/685,506

(22) PCT Filed: Aug. 3, 2022
(86) PCT No.: PCT/AU2022/050831

§ 371 Date: Feb. 22, 2024

(30) Foreign Application Priority Data
Aug. 25, 2021 (AU) 2021221688

(51) Int. Cl. B62D 35/00; B62D 37/02

(52) U.S. Cl. CPC B62D 35/002; B62D 37/02

(57) ABSTRACT

Disclosed herein is a trailable vehicle comprising a body for defining an interior space of the trailable vehicle, the body having at least one side wall extending between a roof and base of the trailable vehicle; wherein at least part of one side wall is directly connected to the roof and substantially formed of metallic sheet material. Also disclosed is a method of manufacturing said trailable vehicle. Also disclosed herein is a trailable vehicle stabilising system for stabilising a trailable vehicle during travel, the system comprising at least one wing member being mountable to a body of the trailable vehicle wherein the wing member(s) are configured to generate a downward force on the trailable vehicle during travel.

### CROSS REFERENCE TO RELATED APPLICATION

The present application claims priority to Australian complete patent application No. 2021221688 filed on 25 Aug. 2021.

### BACKGROUND OF THE INVENTION

### 1. Field of the Invention

The present invention generally relates a trailable vehicle and a method of manufacturing the trailable vehicle.

### 2. Description of the Prior Art

A current method of manufacturing trailable vehicles, such as caravans, horse trailers, box trailers, comprises construction of a supporting framework on which panels can be attached to form walls of the trailable vehicle such as the front, back and side walls. In most cases, the support framework is made of a timber frame with internal ply and aluminium cladding attached external to the frame to form the walls which are then joined together. The panels and framework are then fixed together and sealed for weather proofing, and the framework supports the load of the trailable vehicle. This method is time-consuming and labour-intensive involving numerous components which must be fixed together. Furthermore, the resulting trailable vehicle has numerous joints, which typically mechanical connections, for example, fasteners including rivets, bolts and screws, and adhesives. One problem with mechanical joints is that they increase the risk of water ingress which can reduce the life-span and compromise the structural integrity of the trailable vehicle, such as a caravan.

Other trailable vehicle manufacturing methods include the use of composite panels to form each of front, side and rear walls which are all supported by a horizontal base. The composite panels and chassis base all must be fixed together and sealed to form the final caravan. Although this method may be slightly less time consuming and labour-intensive due to the smaller number of components involved during manufacture, the resulting trailable vehicle still has disadvantages of water ingress that are caused by the numerous sealing joints between the panels and base.

Yet another trailable vehicle manufacturing method involves the construction of a skeleton profile frame and the infilling of the skeleton frame with wall panels. As the wall panels provide some load bearing abilities, this results in a potentially stronger frame. However, this method is also susceptible to water ingress because of the numerous mechanical connections required to join the skeleton profile frame and walls panels together and to seal them against the external environment.

All the current manufacturing methods of trailable vehicles involve the fixing of numerous components such as frames, wall panels and the like, by mechanical connections. This can also result in a heavy trailable vehicle, for example caravans, which is undesirable as caravans must be classified into various weight classes and require a vehicle of appropriate torque for towing. These vehicles also suffer from increased fuel consumption.

Another disadvantage of existing trailable vehicles is the inevitable loosening of the mechanical connections from screws, bolts and nuts, adhesives and silicon over time due to road vibrations, age and other factors. This causes the body of a trailable vehicle to move relative to the chassis during towing. This movement can cause dangerous rolling instability which increases over the lifetime of the trailable vehicle. Further, the loosening of mechanical connections increases the risk of water ingress.

A further disadvantage of the caravans manufactured by the above methods is that the trailable vehicle while being towed experiences stress and strain from the movement of the body relative to the chassis in all directions, i.e. up-down, left-right, front-back, roll, yaw and pitch, as the body twists and is distorted by the forces it experiences while being towed. The increased load, strain and stress on these trailable vehicle bodies reduces the service life of the trailable vehicle and is more difficult to tow than an entirely rigid trailable vehicle.

Hitching a trailable vehicle to a towing vehicle adds weight to the towing vehicle which alters the handling of the towing vehicle due to imbalance of the weight from the front to the rear. This can pose safety concerns, especially at high speeds, from reduced braking efficiency and loss of steering control. Reduced fuel economy and increased tyre wear can also result. In addition, trailer sway is a common issue where the trailable vehicle pivots about the towing point whilst driving which can result from strong winds or buffets from passing large vehicles.

To ameliorate trailer sway, the trailable vehicle may be adjusted to put no more than 10% of the total weight on the towing point. This may involve packing the trailable vehicle manually so that heavy items such as toolboxes, water tanks, motorcycle racks are arranged on the trailable vehicle to ensure that the trailable vehicle is generally level with the towing vehicle at the hitch point and that weight is centred over the axles. Packing a trailable vehicle manually for an optimum weight distribution is not always possible, especially if a trailable vehicle has inherent weight distribution issues which may not be apparent to the vehicle owner. In such a case, it is incumbent on the towing vehicle to travel sufficiently slowly so as to maintain control of the trailable vehicle and to prevent trailer sway.

It is desirable for embodiments of the present invention to address at least partially one or more of the disadvantages of the methods or systems above. Further it is preferred that embodiments of the present invention provide a caravan which provides at least one or more of the following: reduction or elimination of water ingress, increased structural integrity, a more rigid body for better handling, less material usage and reduced weight.

It is also preferred that embodiments of the present invention provide a trailable vehicle which provides one or more of the following: better handling at speed, increased fuel efficiency, more efficient braking, more effective steering, reduced tyre wear and reduction of trailer sway.

It is to be understood that, if any prior art publication is referred to herein, such reference does not constitute an admission that the publication forms a part of the common general knowledge in the art, in Australia or any other country.

### SUMMARY OF THE INVENTION

According to an aspect of the present invention there is provided a trailable vehicle comprising a body for defining an interior space of the trailable vehicle, the body having at least one side wall extending between a roof and base of the trailable vehicle; wherein at least part of one side wall is directly connected to the roof and substantially formed of metallic sheet material.

In an embodiment, the body has two or more side walls which are connected to peripheral edges of the roof. The side walls may be welded to the roof or the side walls and the roof may be formed by folding or pressing a single sheet of metallic material.

By directly connecting at least part of one side wall to the roof, and preferably all the side walls, the load is distributed through the walls and roof, and further the body resists distortion, twisting and/or skewing from movements during towing of the trailable vehicle thereby producing a more rigid body which promotes better handling. More preferably, adjoining peripheral edges of the side walls and roof are further connected to form a weather-resistant trailable vehicle body. By directly connecting the walls and roof together, the direct connections reduce or eliminate the risk of water ingress, further as the direct connections do not loosen over time, water ingress does not increase as it does for other trailable vehicle manufacturing methods. Further as the body has load distributed throughout without requiring mechanical connections and less components, the body can be made of less material and therefore the trailable vehicle can be lighter.

The side walls may be connected to the base by welding. The base may be formed by folding a section of the side wall.

In another embodiment, the body includes a reinforcing means. The roof of the body can have a load-bearing reinforcing means in the form of at least one rib which extends between opposing walls of the body. Preferably, the at least one rib which extends between opposing walls of the body is curved. The at least one rib can comprise a pair of flanged side walls bridged by a bottom wall, wherein flanges of the rib side walls are configured for connection to the roof.

The base can comprise a sheet material having a plurality of longitudinal corrugations. An internal surface of at least one of the side walls can include one or more ribs. The reinforcement means which are directly connected to the roof and side walls increases the strength, load distribution, and rigidity of the trailable vehicle.

In an embodiment, the body further comprises a draw bar directly connected to the base for coupling the trailable vehicle to a vehicle for towing. Preferably, the drawbar can be integrally formed to the lower surface of the base. More preferably, the drawbar is welded to the lower surface of the base.

The metallic sheet material can be steel. Preferably, the steel is rolled steel.

The connections described above are preferably direct connections formed by integrally forming the adjoining components, by folding sheet material or by welding. Having a body that is formed of a more rigid cohesive whole, and a drawbar directly coupled to the body assists in better handling.

According to another aspect of the present invention there is provided a method of manufacturing a body of a trailable vehicle comprising at least one side wall extending from a roof and base of the trailable vehicle, the body being substantially formed from metallic sheet material, the method including: pressing the sheet material to form at least part of one side wall and roof; and directly connecting the side wall to a peripheral edge of the roof such that the side wall extends downwardly from the peripheral edge of the roof.

The step of pressing the sheet material can comprise pressing the sheet material to form a body having a roof flanked by a pair of downwardly extending side walls.

Suitably, the side walls are directly connected at their adjoining peripheral edges to the roof and base to form an interior space of the trailable vehicle body. More suitably, the side walls, roof and base are integrally formed by folding the sheet material or welding the individual components together.

In an embodiment, the method further includes a step of reinforcing the interior surface of the body.

The method may include a step of connecting at least one rib to the interior surface of the roof. Suitably, the at least one rib extends longitudinally between opposing front and rear walls of the body.

The method may include a step of coating the walls and roof with an anti-corrosive coating. The coating can be applied by dip or spray coating the body.

In this specification, the term “direct connection” refers to the connecting of two components of a trailable vehicle together using non-mechanical means such as welding and folding. This term excludes components that are joined together using mechanical means including fastening connections such as rivets, bolts, screw, nails, adhesive and similar type connections.

According to yet another aspect of the present invention there is provided a trailable vehicle stabilising system for stabilising a trailable vehicle during travel, the system comprising at least one wing member being mountable to a body of the trailable vehicle wherein the wing member(s) are configured to generate a downward force on the trailable vehicle during travel.

Preferably, the wing member(s) are configured to increase the front ball weight of the trailable vehicle during travel.

By increasing the downward force on the trailable vehicle when it is in motion, particularly downward forces which increase the front ball weight, the stability of the trailable vehicle is increased. Other benefits can include reduction or elimination of trailer sway, improvement of the handling, fuel efficiency, or safety of the trailable vehicle and towing vehicle.

In an embodiment, the wing member(s) are mountable to a front wall which faces oncoming airflow during travel and/or an oppositely facing rear wall of the trailable vehicle.

The at least one wing member is preferably mounted to the front wall and extends in a direction substantially opposite to that of the oncoming airflow, the wing member being configured to guide the oncoming airflow which is opposite to the direction of travel to increase downward force at a front of the trailable vehicle. The wing member at the front wall (henceforth known as the front wing member) can be configured to direct or deflect oncoming airflow over the roof of the trailable vehicle which increases downward force. In addition, the leading edge of the front wing member also acts to slow the oncoming air to create downward force. To clarify, the front wing member extends in a direction that opposes the direction of the oncoming airflow by having a leading edge which substantially points opposite to the direction of the oncoming airflow.

The front wing member has an upper surface and a lower surface, wherein the upper surface is configured to guide the oncoming airflow at an upper portion of the front wall over a roof of the trailable vehicle. The upper surface is substantially flush with or parallel to an adjacent surface of the vehicle. The adjacent surface of the trailable vehicle can be a portion of the roof section which is intermediate the wing member and a front edge of a substantially horizontal roof section of the body. The adjacent surface can be inclined downwardly to assist the deflection or direction of the oncoming airflow over the trailable vehicle roof.

An angle of attack is a term used in fluid dynamics to describe an angle between a reference line such as a chord of a wing or aerofoil and the relative oncoming airflow. The angle of attack of the front wing member can be angled downwardly relative to the horizon into the oncoming airflow. Preferably, the angle of attack is between 0° to 45° relative to the horizon. Most preferably, the angle of attack is about 15° relative to the horizon.

In an embodiment the front wall comprises a first section configured to guide oncoming airflow downwardly towards the base. Directing oncoming airflow towards the base and under the trailable vehicle body increases the downward force at the front of the trailable vehicle. The front wall further preferably comprises a second section intermediate the first section and the at least one wing member wherein the second section is configured to guide oncoming airflow upwardly towards the at least one wing member on the front wall. The first section and/or second section can comprise substantially flat panels. Alternatively, the first section and/or second section comprises curved panels having a convex shape. The second section is arranged to be positioned above the first section such that the first section guides oncoming airflow below the vehicle body and the second section guides the oncoming airflow towards the wing member.

In an embodiment, the at least one wing member is mounted on an upper end portion of the rear wall. The at least one wing member can be mounted to the rear wall, (henceforth known as the rear wing member) and extends substantially in the direction of the oncoming airflow, the wing member being configured to guide the oncoming airflow to increase downward force at the rear of the trailable vehicle. To clarify, the front wing member extends in a direction of the oncoming airflow by having a leading edge which substantially points the same direction as the oncoming airflow.

The at least one wing member has an upper surface and a lower surface, wherein the upper surface is configured to guide the oncoming airflow beyond the rear end of the trailable vehicle to reduce turbulence. The upper surface can be substantially flush with or parallel to a roof of the vehicle. Alternatively, the upper surface is angled upwardly relative to a roof of the vehicle.

In an embodiment, the stabilising system comprises both the wing member mounted to the front of the trailable vehicle as described above and the wing member mounted to the rear of the trailable vehicle as described above. Each wing member can be integral to the body of the trailable vehicle. Alternatively, each wing member is a separate component which can be mounted to the trailable vehicle. The wing members can be mounted as after market components. Most preferably, the front and rear wing members are configured so as to maintain the correct front ball weight when the trailable vehicle is in motion for the elimination or reduction of trailer sway, optimal stability, fuel efficiency and safety, increased driver control and braking and reduction of tyre wear.

The stabilising system can also comprise at least one diffusing element mountable to the body of the trailable vehicle for reduction of turbulent air flow and/or drag forces. Preferably, the at least one diffusing element has an upright planar section having a leading edge which points into the oncoming airflow when the trailable vehicle is in motion. The or each diffusing element can be fin-shaped element having a leading edge which reduces the turbulence of the airflow. The at least one diffusing element can be mountable at a rear end portion of the roof. The stabilising system can include multiple diffusing elements mounted in a spaced-apart configuration across a width of the rear end portion of the roof.

The at least one wing member, being either or both of the front wing member or rear wing member, can extend substantially between side walls of the trailable vehicle body. This ensures that the air flow is directed over the entire width of the vehicle body. The at least one wing member can taper at opposing end portions towards the side walls of the body of the trailable vehicle. Tapering, or rounding the opposing end portions of the at least one wing member can assist to smooth the airflow at those end portions.

According to a further aspect of the present invention there is provided a trailable vehicle having a stabilising system as described above.

According to a further aspect of the present invention there is provided at least one wing member being for use in the stabilising system as described above and mountable to a trailable vehicle.

### BRIEF DESCRIPTION OF THE DRAWINGS

One or more embodiments of the present invention will hereinafter be described with reference to the accompanying Figures, as follows.

FIG. 1 is a rear perspective view of a trailable vehicle according to one embodiment of the present invention.

FIG. 2 is an enlarged view of a portion of the floor of the trailable vehicle of FIG. 1.

FIG. 3 is a perspective view of a reinforcing rib for a roof of the trailable vehicle of FIG. 1.

FIG. 4 is a side view of the trailable vehicle of FIGS. 1 and 3.

FIG. 5 is a top view of the trailable vehicle of FIG. 4.

FIG. 6 is a perspective view of the front portion of the trailable vehicle cutaway at lines D to D as shown in FIG. 5.

FIG. 7 is an enlarged view of a portion of the trailable vehicle of FIG. 6.

FIG. 8 is a perspective view of the bottom of the trailable vehicle of FIG. 6.

FIG. 9 is an enlarged view of a portion of the trailable vehicle of FIG. 8.

FIG. 10 is a schematic of the steps of an exemplary method for manufacture of a trailable vehicle body.

FIG. 11 is a cross-section view of the body of the trailable vehicle.

FIG. 12 is a rear perspective view of a trailable vehicle having a wing member on a front wall according to another embodiment of the present invention.

FIG. 13 is a top view of the trailable vehicle of FIG. 12.

FIG. 14 is an enlarged side view of the trailable vehicle of FIGS. 12 and 13.

FIGS. 15 to 19 are enlarged side views of the front wall of the trailable vehicle having various wing members according to alternative embodiments of the present invention.

FIGS. 20 to 23 are enlarged side views of different profiles of the front wall of the trailable vehicle according to alternative embodiments of the present invention.

FIG. 24 is a front perspective view of a trailable vehicle having a wing member on a rear wall according to yet another embodiment of the present invention.

FIG. 25 is a top view of the trailable vehicle of FIG. 24.

FIG. 26 is an enlarged side view of the trailable vehicle of FIGS. 24 and 25.

FIGS. 27 to 30 are enlarged side views of the rear wall of the trailable vehicle having various wing members according to alternative embodiments of the present invention.

FIG. 31 is a plot of aerodynamic forces on a surface adjacent to a front wing member for a conventional trailable vehicle design.

FIG. 32 is a plot of aerodynamic forces on a surface adjacent to a front wing member for the trailable vehicle of FIG. 1.

FIG. 33 is a plot of aerodynamic forces on a roof of a conventional trailable vehicle design.

FIG. 34 is a plot of aerodynamic forces on the roof of the trailable vehicle of FIG. 1.

FIG. 35 is a plot of aerodynamic forces on a rear wall of a conventional trailable vehicle design.

FIG. 36 is a plot of aerodynamic forces on a rear wall of the trailable vehicle of FIG. 1.

FIG. 37 is a plot of aerodynamic forces on a drawbar of a conventional trailable vehicle design.

FIG. 38 is a plot of aerodynamic forces on a drawbar of the trailable vehicle of FIG. 1.

FIG. 39 is a plot of velocity contours and velocity vectors of a conventional trailable vehicle design.

FIG. 40 is a plot of velocity contours and velocity vectors of the trailable vehicle of FIG. 1.

### DETAILED DESCRIPTION

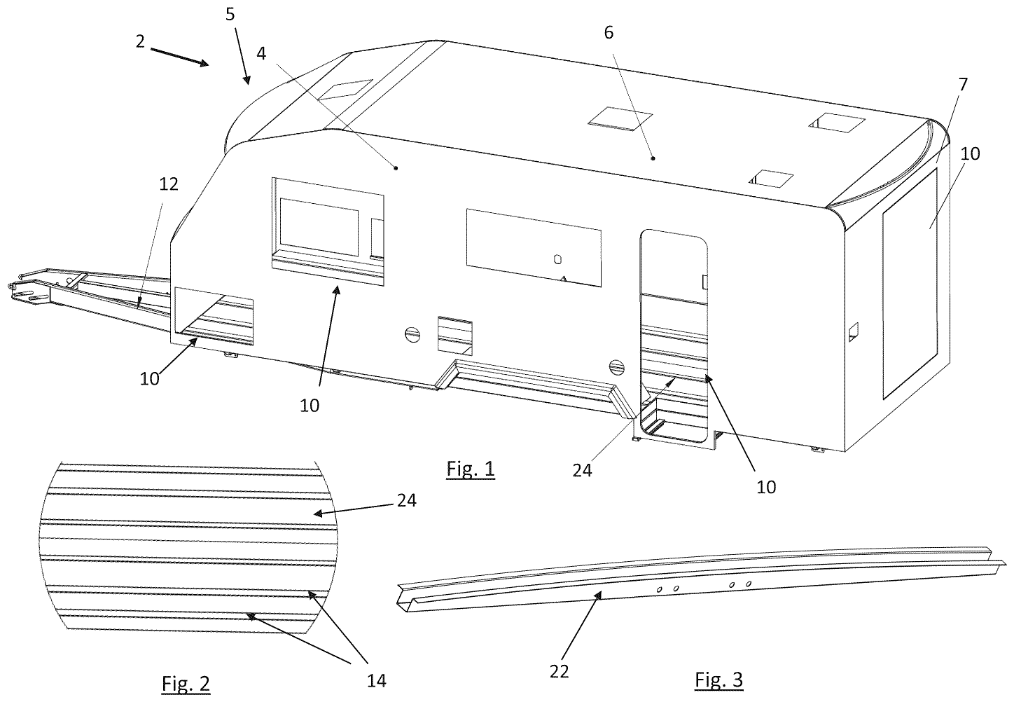

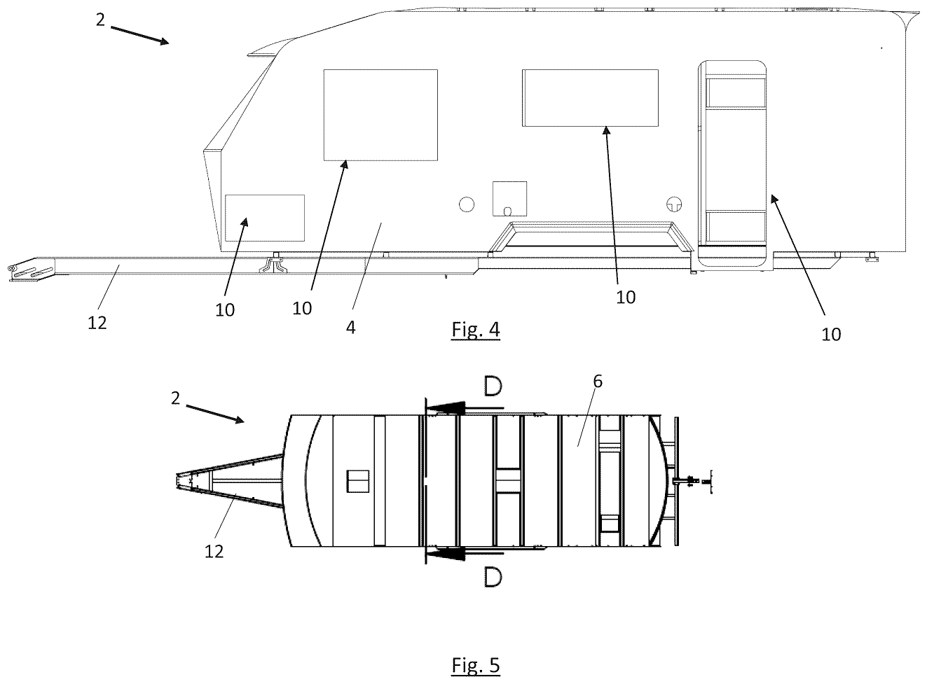

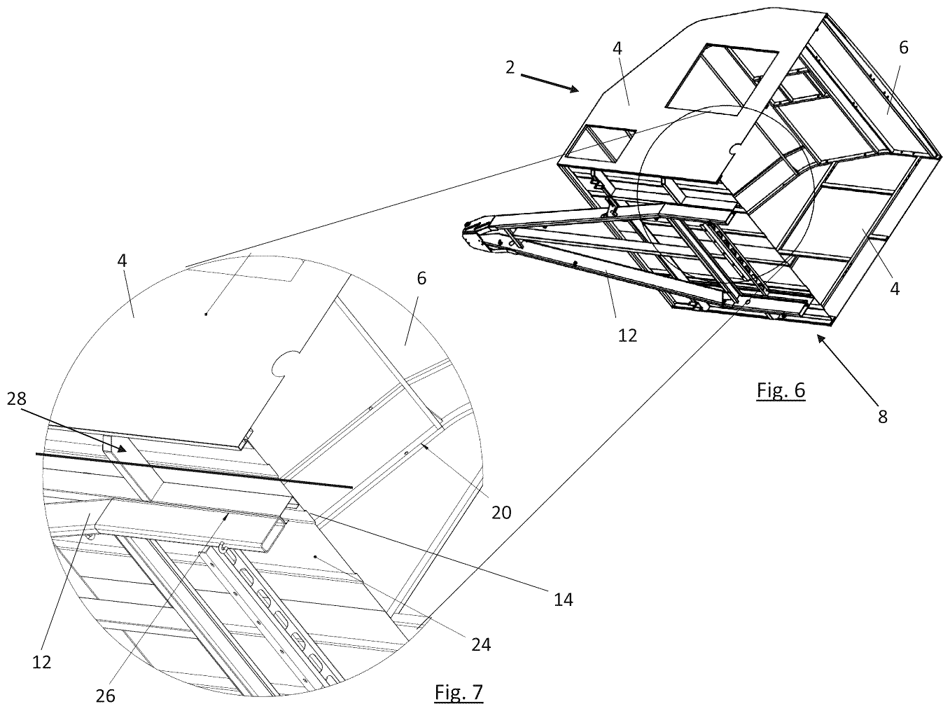

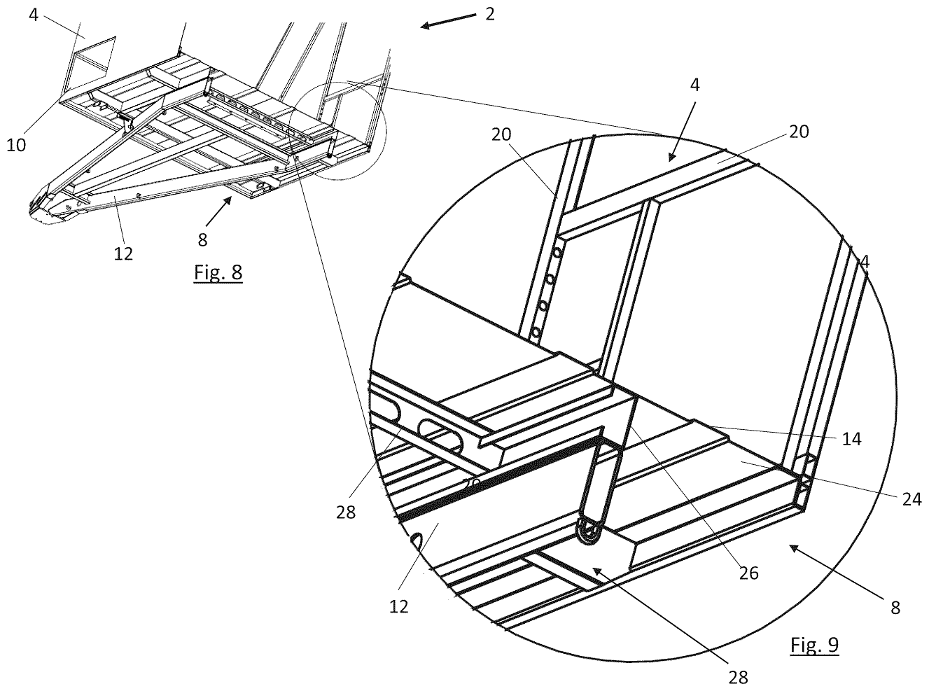

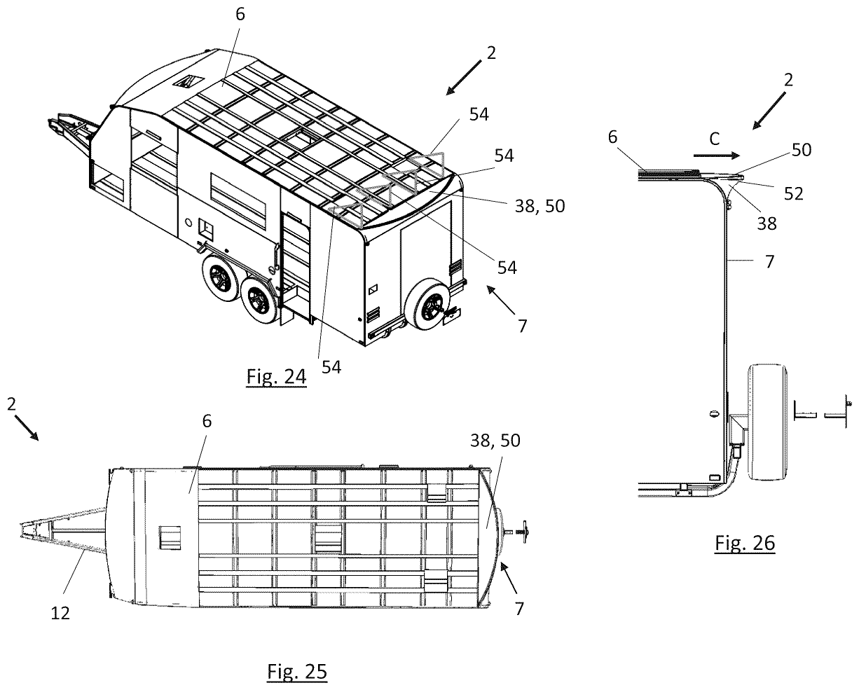

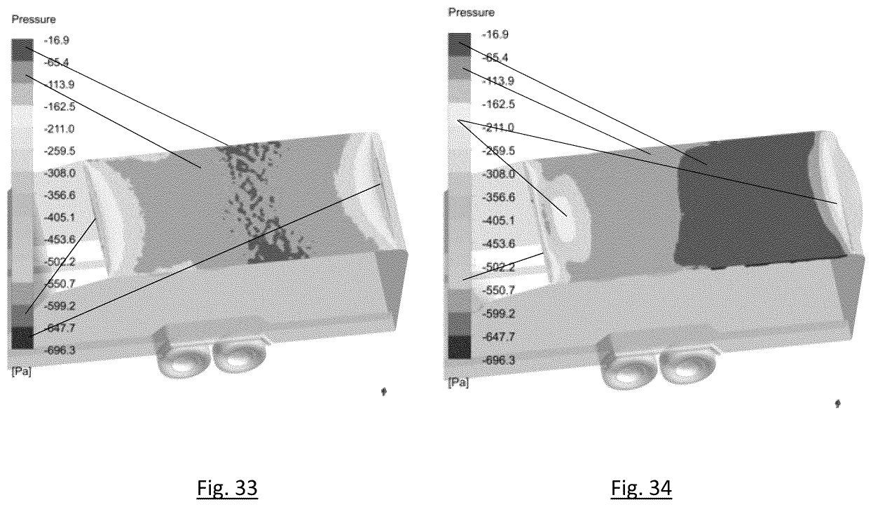

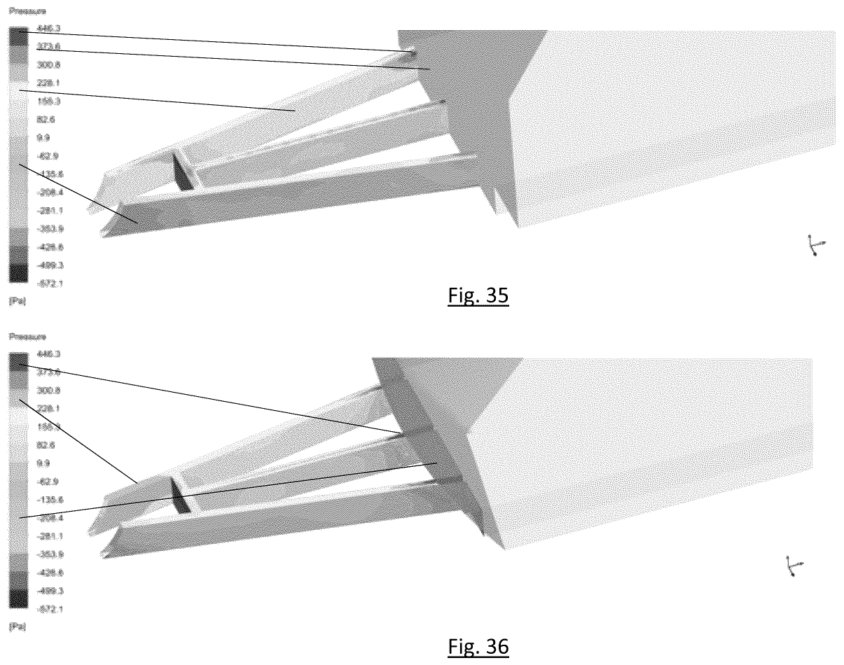

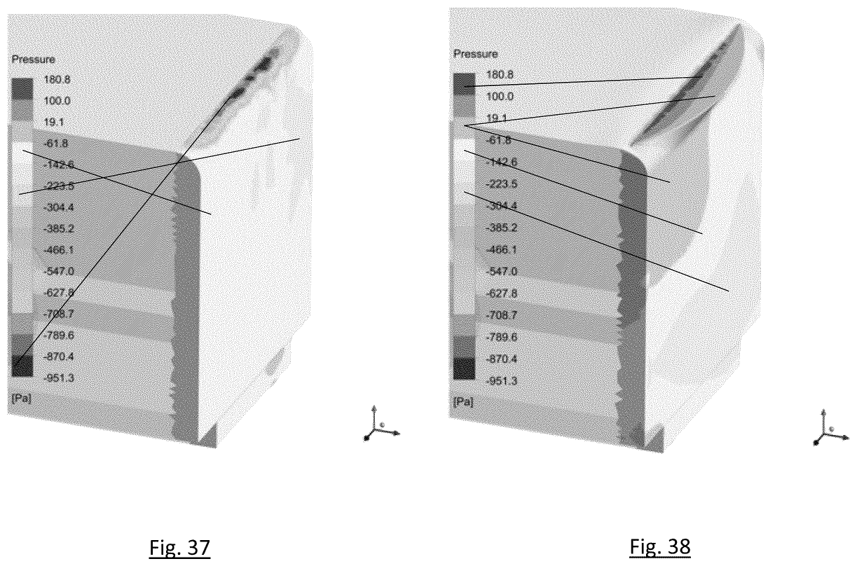

Referring now to FIGS. 1 to 40, there is described a trailable vehicle having a body 2 for defining an interior space of the trailable vehicle, and a method of manufacturing the trailable vehicle. The trailable vehicle is exemplified in the Figures as a caravan but can encompass other types of trailable vehicles such as horse floats, utility trailers for holding tools or other equipment, box or freight trailers or the like.

The body 2, as illustrated in the Figures, has peripheral walls 4 comprising a front wall 5, a rear wall 7 which substantially opposes the front wall, and a pair of side walls which extend between the front and rear walls. The body 2 includes a roof which extends between the upper portions of the peripheral walls 4 to form a roof 6 of the trailable vehicle. At least one peripheral wall 4, 5, 7 is directly connected to the roof 6 so that it extends substantially downwardly from a peripheral edge of the roof 6. The peripheral walls 4, 5, 7 and roof 6 are formed of metallic sheet material. Holes 10 can be punched into the metallic sheet material to allow for windows, doors, skylights, and service and utility access such as power, sewerage, water and the like.

As illustrated in the example trailable vehicle of a caravan of FIGS. 1, 6, 10 and 11, the peripheral walls 4, 5, 7 and roof 6 are all formed from sheet material with the peripheral edges of the roof 6 and the peripheral walls 4, 5, 7 directly connected. By directly connecting at least one side wall to the roof, and preferably all the front 5, rear 7 and side walls 4, the load is distributed between the peripheral walls 4, 5, 7 and roof 6 and enhances the ability of the body 2 to resist torsional stresses including distortion, twisting and/or skewing from movements during towing of the trailable vehicle by producing a more rigid body 2 which promotes better handling. The connected peripheral walls 4, 5, 7 and roof 6 forms a shell 18 on which an anti-corrosive coating can be applied, for example by dip or spray coating. The lower portions of the side walls 4 are also preferably directly connected to the base 8, also known as a chassis. The directly connected peripheral walls 4, 5, 7, roof 6 and base 8 forms what is known as a ‘monocoque’ chassis. Having the body and chassis structurally integrated and manufactured as one piece reduces or substantially eliminates body movements relative to the chassis.

The adjoining edges of the peripheral walls 4, 5, 7 can be also directly connected so as to form a weather-resistant trailable vehicle body 2. The direct connections of the peripheral walls 4, 5, 7 to each other, to the roof 6 and to the base 8 are preferably non-mechanical connections which can be in the form of welding, integrally forming the roof 6, base 8 and at least part of one side wall or walls 4, 5, 7 or folding a single sheet of metallic material. The adjoining edges are defined in this disclosure as the side edges of the walls 4, 5, 7 that are not yet connected and must be joined together to form the corners of the trailable vehicle.

Mechanical connections are defined in this disclosure as being fastening connections such as rivets, bolts, screw, nails, adhesive and similar type connections.

Suitable metallic material for the present invention include steel, aluminium, iron and alloys thereof.

Directly connecting the peripheral walls and roof together reduce or eliminate the risk of water ingress. The direct connections also do not loosen over time to reduce or prevent water ingress compared to other trailable vehicle manufacturing methods. Furthermore, an integrally formed body without mechanical connections allows it to be constructed from less material and results in a lighter trailable vehicle compared to an equivalent size prior art trailable vehicle.

The body includes at least one reinforcing means. For example, the internal surface of the side walls 4 also includes a plurality of ribs 20 which reinforce the side walls 4. As illustrated in FIGS. 6, 9 to 11, some of the ribs 20 of the side walls 4 are horizontally oriented however it can be appreciated that the ribs 20 may be oriented in other directions, i.e. vertically depending on load and design requirements.

The roof 6 may also have at least one load-bearing reinforcing means in the form of at least one rib 22 which extends between opposing peripheral walls 4, 5, 7 of the body. In the exemplary embodiment of FIGS. 1 to 3, the at least one rib 22 extends between the front and rear walls 5, 7, however the at least one rib 22 can also be located between opposing side walls 4. The at least one rib 22 can have a pair of flanged walls bridged by a bottom wall, wherein flanges of the rib side walls are configured for connecting to the roof 6, for example by welding or other direct connection means, as illustrated in FIG. 3. The at least one rib 22 can be curved thereby forming a so-called ‘banana’ rib for additional reinforcement.

As illustrated in FIGS. 1 and 2, the base 8 includes an internal surface formed of metallic sheet material which forms the internal floor 24 of the body. In an embodiment, the floor 24 is directedly connected to the base 8, for example by welding. The internal floor 24 has a plurality of longitudinal corrugations 14 which can assist to reinforce the floor 24. The base 8 also comprises a plurality of longitudinal beams 26 which extend between the front and rear of the base 8 for reinforcement of the base 8. A number of reinforcing elements 28 can extend laterally from those beams 26 for additional reinforcing, as illustrated in FIGS. 6 to 9.

The reinforcement means, such as the ribs 20, 22 which are directly connected to the roof 6 and walls 4, 5, 7 greatly increase the strength, assists to distribute load, and produces a more rigid body.

As particularly illustrated in FIGS. 1 and 5 to 9, the drawbar 12 of the trailable vehicle 2 is connected to the base 8 for coupling the trailable vehicle 2 to another vehicle for towing. The drawbar 12 can be integrally formed to the lower surface of the base 8 or by welding, for example by directly connecting to a longitudinal beam 26 or other structure on the base 8. Having a body 2 that is formed of a more rigid cohesive whole, and a drawbar directly coupled to the body assists in better handling.

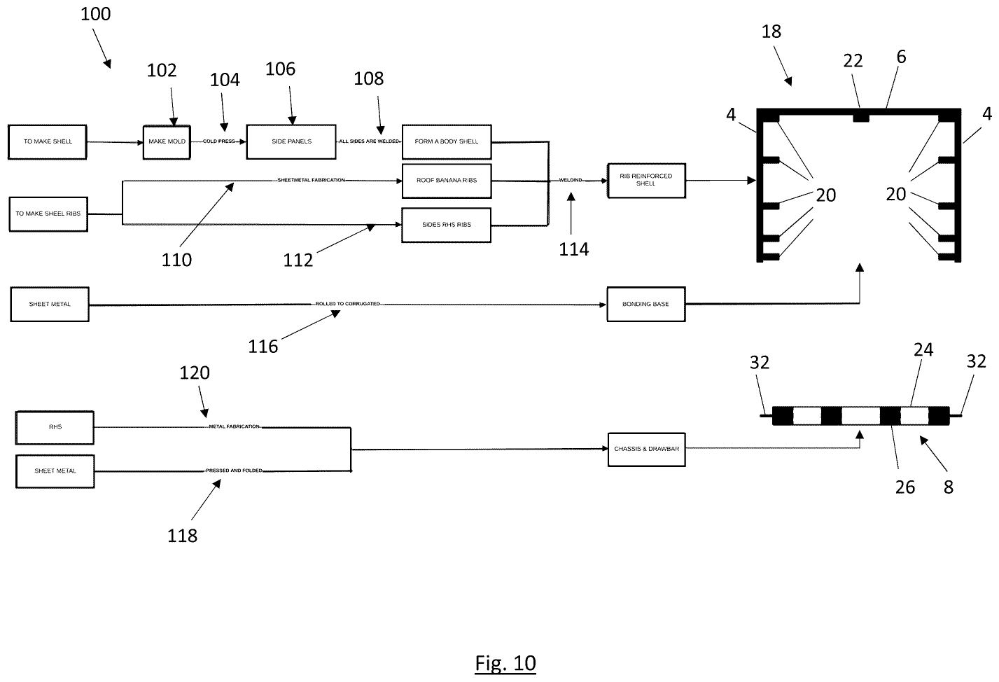

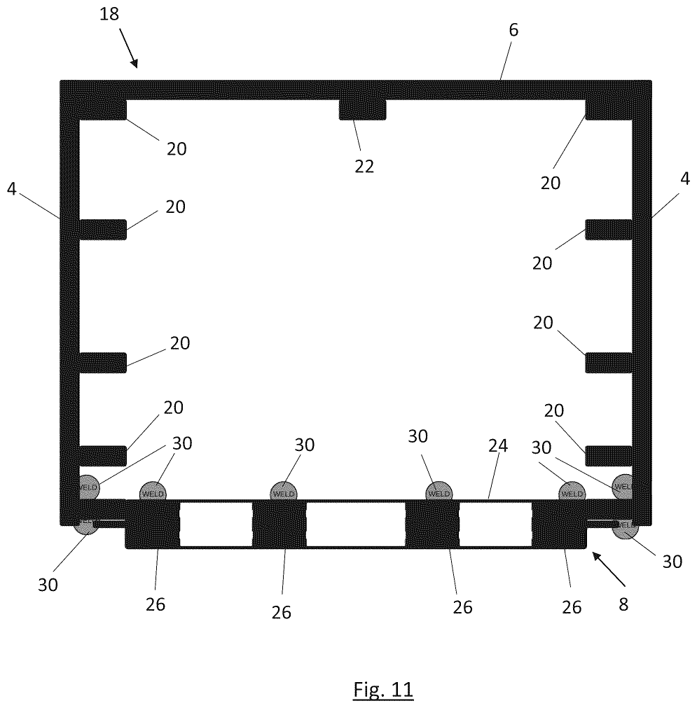

The trailable vehicle 2 can be manufactured by an example method 100 as shown in the flow chart of FIG. 10 to produce the body as illustrated in FIG. 11. First, a mould is formed (step 102) and sheets of metallic material are cold pressed (step 104) to form panels (step 106) which can be used to construct the peripheral walls 4, 5, 7 i.e. the front, rear and side walls. Another sheet of metallic material can be used to form the roof portion 6. Alternatively, a single sheet of metallic material could be folded to form the roof portion 6 and at least part of a wall 4, 5, 7 or two or more wall portions.

The roof portion 6 and wall panels 4, 5, 7 are welded together to form the shell 18 as indicated in step 108. In step 110, sheet metal fabrication is used to form ribs 22 to make the roof “banana” ribs while ribs 20 for the side walls 4 are formed in step 112. Welding the roof ribs 22 and ribs 20 to the walls 4, 5, 7 in step 114 results in a rib-reinforced shell 18. An anti-corrosive coating can be applied to the shell 18 without the ribs 20, 22 or rib-reinforced shell, for example by dip or spray coating. This reduces the risk of the trailable vehicle corroding over its lifetime.

A piece of metallic sheet metal can be rolled and corrugated in step 116 to form the internal floor 24.

To produce the trailable vehicle, the rib reinforced shell 18 can be directly connected to side edges of the base 8 and welded at the example weld points 30 indicated in FIG. 11. In step 118, sheet metal is pressed and folded to produce the chassis members in the form of reinforcing beams 26, 28 of the base 8, and the drawbar 12 can be produced by metal fabrication in step 120. The base 8 can include longitudinally extending flanges 32 to facilitate connection to the shell, i.e. when being welded.

This forms a trailable vehicle body 2 that is held together and connected to a chassis by non-mechanical means. The manufactured trailable vehicle may possesses one or more of the following advantages over body-on-frame trailable vehicles including (i) reduced weight, (ii) reduced water ingress, and (iii) increase structural stability.

As illustrated in FIGS. 1, 4, 5 and 12 to 40, there is also described a trailable vehicle having a body 2 which is configured for stabilising the trailable vehicle during travel according to preferred embodiments of the present invention.

There is also described a trailable vehicle stabilising system according to further embodiments of the present invention, with reference to FIGS. 1, 4, 5 and 12 to 41, for stabilising the trailable vehicle during travel. The stabilising system generates a downward force on the vehicle when the vehicle is in motion to reduce trailer sway.

The stabilising system comprises at least one wing member 36, 38 which is mountable to either the front wall 5 or an oppositely facing rear wall 7. The front wall 5 generally faces oncoming airflow during travel. The use of the wording ‘wing member’ is used throughout this disclosure to describe a device which can generate downward forces and reduce drag forces which is intended to be differentiated from spoiler elements which tend to be designed to disrupt airflow patterns.

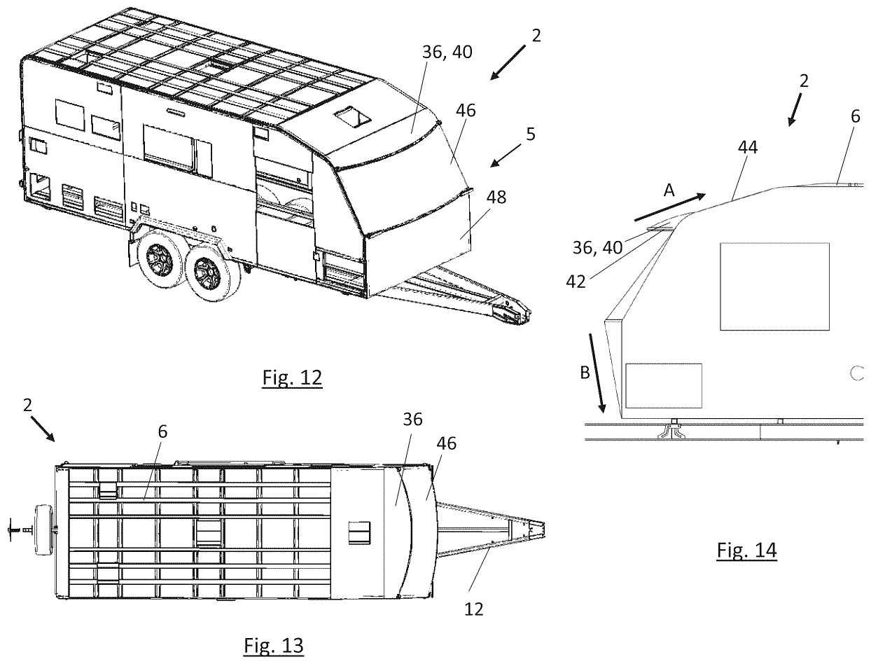

FIGS. 12 to 14 are views of a trailable vehicle having the stabilising system comprising a wing member 36 on a front wall 5 of the trailable vehicle while FIGS. 24 to 26 are views of a trailable vehicle having a stabilising system comprising a wing member 38 on the rear wall 7 of the trailable vehicle. In a most preferred embodiment, the trailable vehicle has both a wing member 36 mountable to the front wall 5 and a wing member 38 mountable to a rear wall 7, as illustrated in FIGS. 1, 4 and 5.

The front wall wing member 36 can generate the same or greater downward force compared to the rear wall wing member. Desirably, the front wall wing member 36 generates a greater downward force than the rear wall wing member 38. This will increase the front ball weight of the trailable vehicle to reduce sway when the trailable vehicle is in motion.

With particular reference to FIGS. 12, 13 and 14, there is shown the trailable vehicle having a wing member 36 mounted on the front wall 5. The wing member 36 is configured to guide the oncoming airflow to stabilise the trailable vehicle, particularly the front end of the trailable vehicle. The wing member 36 has an upper and lower surface 40, 42 where the upper surface is generally angled downwardly so as to guide the oncoming airflow from the front wall upwardly to the roof 6 as indicated by arrow A in FIGS. 14 to 18. Generally speaking, the wing member 36 has an angle of attack which can be angled between 0° to 45° (preferably about) 15° relative to the horizon to provide a downwardly force which increases as the ongoing airflow velocity increases. Therefore, advantageously, the stabilising system provides stability for improved handling and safety at speeds.

The front wall 5 comprises a profile section 44 intermediate the roof 6 and the wing member 36 such that the wing member 36 is generally mounted below the height of the roof 6, as exemplified in FIGS. 14 to 18. The profile section 44 is configured to guide airflow from the wing member 36 to the roof 6. As illustrated in FIGS. 14 to 18, the wing member 36 is angled downwardly from the roof 6 to the wing member 36 opposite to the direction of oncoming airflow. In the embodiment shown in FIG. 14, the profile section 44 is substantially flush to or parallel to the upper surface 40 or the angle of attack of the wing member.

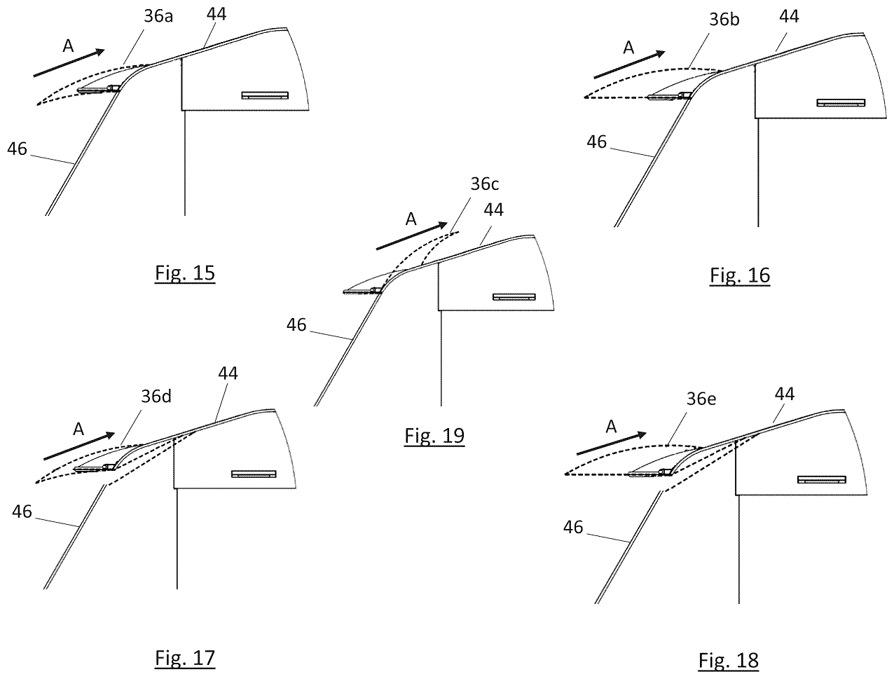

As shown in FIGS. 15 to 19, the wing member 36 can be configured so as to have a variety of cross-section side profiles (shown in dotted lines) 36a, 36b, 36c, 36d, 36e which the applicant considers to be able to provide the downwardly force which assists in stabilising the front of the vehicle. The profile of the wing member 36 can be selected on a basis which includes one or more factors such as the type, size or shape of the trailable vehicle, towing capacity of the towing vehicle, or aesthetic factors.

The wing member can comprise upper and lower surfaces separated by an edge in which the area of the upper surface is larger than the lower surface for diverting the oncoming airflow upwards. Whilst the profile of the upper and lower surfaces is variable, the upper surface has a convex profile while the lower surface can have either a convex or planar profile.

The wing members 36a to 36d have profiles which generally extend into the oncoming airflow, i.e. where the leading edge of the wing member points into the oncoming airflow however other profiles for the wing member are possible, as illustrated in FIG. 19 where the wing member 36e extends generally opposite to the oncoming airflow, i.e. the leading edge points in the same direction as the oncoming airflow. Wing member 36e has an angle of attack generally parallel but in an opposite direction to that of wing members 36a to 36d to guide the airflow from the front wall 5 upwardly to the roof 6.

The front wall 5 also comprises two profile sections 46, 48 which are generally formed of substantially flat panels located intermediate the base 8 and wing member 36 as illustrated in FIGS. 12 to 14. The lower edge of profile section 46 is contiguous with the upper edge of profile section 48. The profile sections 46, 48 are configured to guide oncoming airflow at the lower part of front wall 5 downwardly, as shown in the direction of arrow B, so as to reduce drag forces and increase downwards forces on the vehicle.

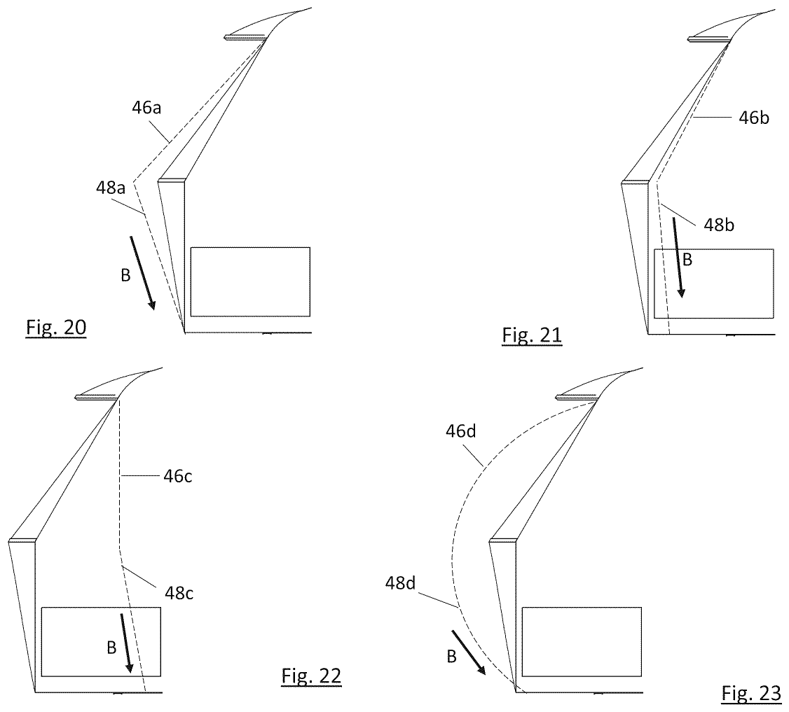

As shown in FIGS. 20 to 23 the profile sections 46, 48 can be configured so as to have a variety of cross-section side profiles (shown in dotted lines) 46a to 46e, 48a to 48e which the applicant considers to be able to provide the downwardly force which assists in stabilising the front of the trailable vehicle. In particular, the lower profile section 48 is configured so as to angle downwardly and rearwardly. The lower profile section 48 can be angled between 0° to about 25° relative to the vertical to guide the oncoming airflow towards the base 8 however in a most preferred embodiment, the lower profile section 48 is angled at about 10° to the vertical a as exemplified in FIG. 14. In an alternative embodiment illustrated in FIG. 22 the profile sections 46, 48 have a convex curve side profile.

With particular reference to FIGS. 24, 25 and 26, there is shown the stabilising system for the trailable vehicle having a wing member 38 mounted on the rear wall 7. The wing member 38 is configured to guide the oncoming airflow to stabilise the trailable vehicle, particularly the rear end of the trailable vehicle. The wing member 38 is configured to reduce drag forces by decreasing turbulence, and/or, to increase the downwards force at the rear of the trailable vehicle.

The wing member 38 has upper and lower surfaces 50, 52 where the upper surface 50 is generally angled parallel to or generally upwardly so as to guide the oncoming airflow from the roof as indicated by arrow C in FIGS. 26 to 30. Generally speaking, the wing member 38 has an angle of attack which can be angled between −10° to 45° relative to the horizon to provide a downwardly force which increases as the ongoing airflow velocity increases and which can also reduce the turbulence typically generated at the rear of trailable vehicles. Therefore, advantageously, the stabilising system having a rear wing member 38 provides stability at the rear end of the trailable vehicle for improved handling and safety at speeds.

A downwards force at the rear of a trailable vehicle is not usually considered desirable as this can mean that the trailable vehicle may tend to tip rearwardly which causes the trailable vehicle to be higher than the towing vehicle at the hitch point which reduces braking efficiency and stability. However, the rear downwards force provided by the stabilising system can be considered to assist in balancing trailable vehicles which are already front-heavy, either by structure or additional load due to accessories such as water tanks or the like. Further, the rear downwards force provided by wing member 38 can act to balance the downwards force which is provided by the front wing member 36, when the trailable vehicle is in motion, and particularly at high speeds. The trailable vehicle, having a stability system comprising both wing members 36 and 38, as illustrated in FIGS. 1 to 3, therefore has downwards forces at both the front and rear which acts to balance the overall weight distribution when the trailable vehicle is in motion, particularly at high speeds. In addition, the downward forces from the wing members 36, 38 push the trailable vehicle closer to the ground for better stability at speed. In a most preferred embodiment, the front and wing members are configured to provide the correct front ball weight when the trailable vehicle is in motion so as to provide optimal stability and eliminate trailer sway.

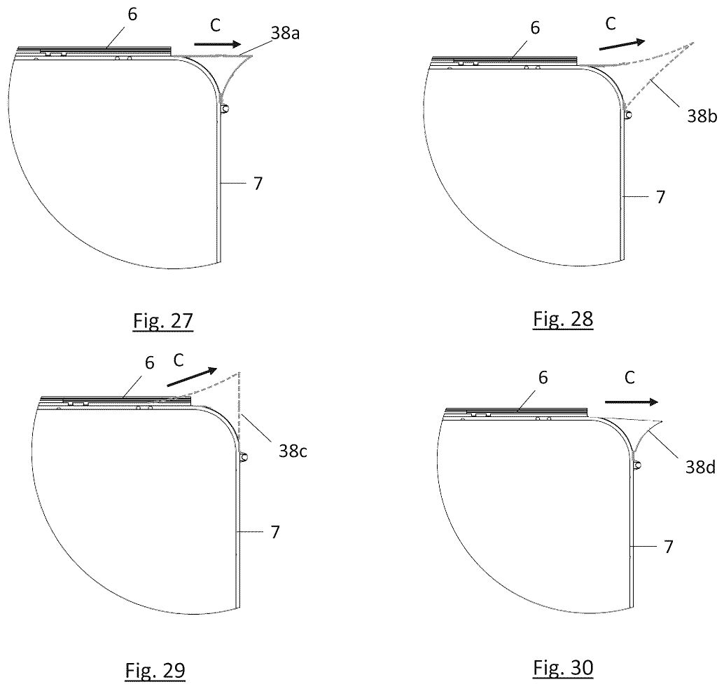

As shown in FIGS. 27 to 30 the wing member 38 can be configured so as to have a variety of cross-section profiles (shown in dotted lines) 38a, 38b, 38c, 38d, which the applicant considers to be able to provide the downwardly force to stabilise the rear of the vehicle. The shape and size of the wing member 38 can be selected on a basis which includes one or more factors such as the type, size or shape of the trailable vehicle, towing capacity of the towing vehicle, or aesthetic factors.

The wing members 36, 38 can also have a convex curve top profile, as exemplified in FIGS. 5, 13, 24 which assists to guide the oncoming airflow about the sides of the trailable vehicle, and further reduce drag forces. In particular, the side end portions of wing members 36, 38 taper or are smoothed at the side walls 4 to maintain smooth airflow at the sides of the trailable vehicle. The wing members 36, 38 extend across the entire width of the trailable vehicle, i.e. extend from one side wall to the side wall, to ensure that the airflow is directed over the entire width of the trailable vehicle body.

The stabilising system can also comprise means for improving airflow at the rear the trailable vehicle which is configured to reduce the drag forces or reduce turbulence at the rear of the trailable vehicle. The means for improving airflow can comprises at least one diffusing element 54 mountable at the rear of the trailable vehicle. As illustrated in a preferred embodiment of FIG. 24, the means for improving airflow comprises four spaced-apart diffusing elements. The diffusing elements are fin-shaped, where each of the fin-shaped elements has a plane which is parallel to the oncoming airflow and where the fin-shaped elements have a leading edge which tapers opposite the direction of the oncoming airflow. It is understood that the shape and size of the diffusing elements, including those currently known for use on passenger vehicles, can be selected on a basis by a person skilled in the art which includes one or more factors depending on the estimated drag forces and the amount of reduction of turbulence and drag forces to be reduced.

The applicant has conducted a comparative computation fluid dynamic (CFD) study on a conventional caravan design and a caravan having the stability system according to a preferred embodiment of the present invention. The study calculates the aerodynamic forces, namely the drag and lift forces where the drag forces affect the fuel consumption while the lift force affects the caravan stability at high speeds. The results of the study are provided in the following paragraphs and as plots in FIGS. 32 to 40.

When a trailable vehicle including both front and rear wing members 36, 38 according to an embodiment of the invention is in motion, the oncoming air flows from the front to the rear of the vehicle and will flow over the top and below the vehicle body 2. As oncoming air flows over the top of the vehicle body 2, it first encounters the leading edge of the front wing member 36. This slows the oncoming air ahead of the front wall 5 and creates a downward force on the top of the vehicle body 2. The front wing member then deflects the oncoming air upwards creating downward forces and reduces air resistance. The inclined profile section 44 also assists to deflect the oncoming air flow and increases the downward force. The oncoming air flow is also diverted downwardly under the vehicle body 2 by profile section 48 which reduces drag forces and increases downward force. Therefore, the profile of the front wall 5 of the vehicle body 2, including the front wing member 36, creates downward forces which advantageously increases the front ball weight when the trailable vehicle is in motion which stabilises the trailable vehicle.

As the oncoming airflow flowing above and below the vehicle body 2 and reaches the rear wing member 38, the rear wing member 38 acts to reduce drag and increase the downwards force by dispersing the air flow around the rear of the trailable vehicle. Generally, it has been understood that it is not desirable to introduce additional downward force at the rear of a trailable vehicle however the rear wing member 38 can act in this embodiment to balance the overall weight distribution, including the downwards force introduced by the front wing member 36, while the trailable vehicle is in motion, thereby increasing the overall stability of the trailable vehicle.

The 3D steady CFD model was built on ANSYS platform and Solidworks was used to create the clean geometry from the 3D model of each design. Then Design Modeler was used in the second step for building the domain around the caravan and vehicle bodies. ANSYS Meshing was used for mesh, then finally ANSYS Fluent as a solver. K- [symbol] SST turbulence model was used with Y+=1 to solve the viscous sublayer adjacent to the walls of the caravan and the vehicle to obtain accurately the aerodynamic forces. About 30 million cells were used to create enough mesh density on the bodies surfaces and around them. The travelling speed of the vehicles was considered as 100 km/h.

The results presented in Table 1 below compares the drag and lift forces for a conventional caravan and a caravan having the stability system of a preferred embodiment of the present invention. The stability system is able to provide a 7.45% lower drag force for a caravan over the conventional design. In addition, there is an increase in overall downwards force of 168.9% for a caravan having the stability system when compared to the conventional design.

TABLE 1
Comparison of drag and lift forces on different parts of a
conventional caravan and a caravan having the stability system
of a preferred embodiment of the present invention.

| | Drag | | | Lift | | |
|---|---|---|---|---|---|---|
| | | | En- | | | En- |
| | | | hance- | | | hance- |
| | F_d | C_d | ment | F_l | C_l | ment |
| Caravan | (N) | (—) | Ratio | (N) | (—) | Ratio |
| Conven- | 1451.4 | 0.58157 | — | 333.9 | 0.13380 | — |
| tional | | | | | | |
| design | | | | | | |
| Caravan | 1343.3 | 0.53825 | 7.45% | −230.1 | −0.09218 | 168.90% |
| having | | | | | | |
| stability | | | | | | |
| system | | | | | | |

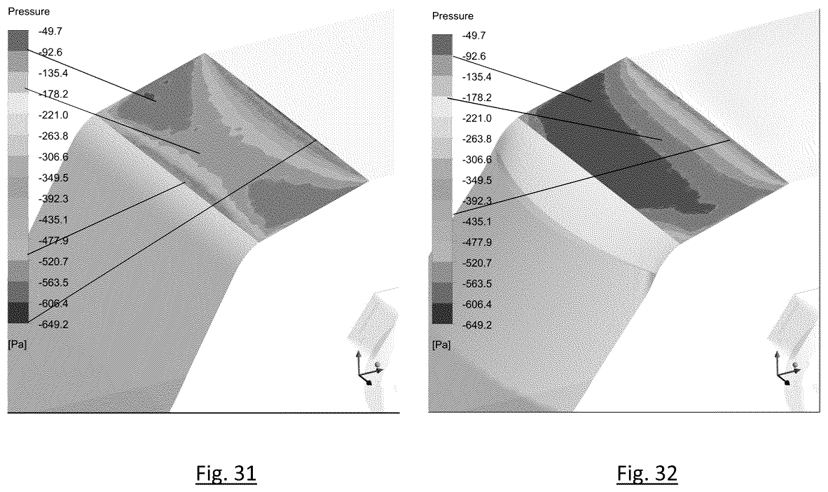

FIGS. 32, 34, 36 and 38 are contour plots of the pressure contour (Pa) of parts of the trailable vehicle having the stability system of FIGS. 1 to 5 which are compared to similar plots in FIGS. 31, 33, 35 and 37 for a conventional caravan design. The pressure contour plots show substantial increases in pressure for the parts of the caravan having the stability system of the embodiments of the present invention. The solid lines indicate the contour sections which align to the pressure indicated in the pressure bar scale.

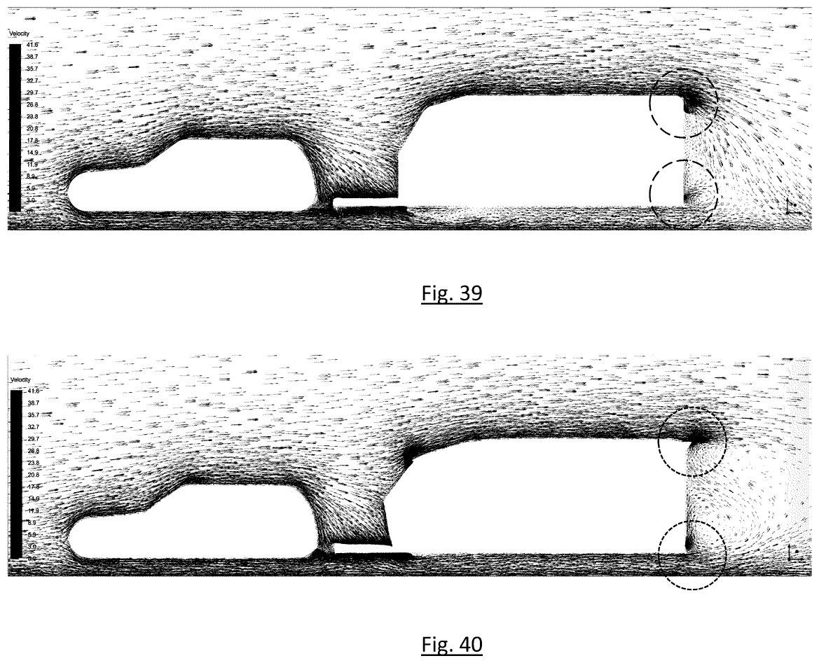

Lastly, FIGS. 39 and 40 are velocity contour and velocity vector plots for the overall side profile trailable vehicle having the stability system of FIGS. 1 to 5 respectively. In the areas indicated by the circles in dashed lines in FIG. 39, it has been calculated that the conventional caravan design has areas of turbulence at the rear of the vehicle. In comparison, in the areas indicated by the circles in dotted lines, it has been calculated that the stability system reduces the drag forces and turbulences, and this in turn improves the stability of the trailable vehicle.

The table below (Table 2) compares the computed drag and lift forces on the different parts of the caravan having the present stability system and parts of a conventional caravan showing a significant decreased overall drag forces and significant decrease in lift forces, i.e. increase in downwards force.

TABLE 2
Comparison of drag and lift forces on different parts of a
conventional caravan and a caravan having the stability system
of a preferred embodiment of the present invention.

| | Drag Forces F_d (N) | | Lift Forces F_l (N) | |
|---|---|---|---|---|
| Part of trailable | Conventional | Stability | Conventional | Stability |
| vehicle | Design | system | Design | system |
| Profile section 44 | −96.368 | −59.082 | 319.956 | 194.500 |
| Roof 6 | 5.260 | −0.774 | −1086.609 | 816.193 |
| Towbar 12 | 0.867 | −22.982 | −32.746 | −72.054 |
| Rear wall 7 | 639.433 | 519.651 | 178.446 | −50.036 |

It can be understood that while the illustrated embodiments describe a trailable vehicle having a body which is configured to stabilise the trailable vehicle during towing and where the stability system comprising one or more wing members and/or a front wall panel are integral to the body of the trailable vehicle, the stabilising system can be applied to other trailable vehicles by mounting one or more wing members, a front wall panel or by otherwise modifying the body of a conventional trailable vehicle by way of after-market parts or accessories.

It will be understood to persons skilled in the art of the invention that many modifications may be made without departing from the spirit and scope of the invention. For example, in the method described above, the specific processes such as cold pressing, sheet metal fabrication or welding are example processes that can be used, and other equivalent metal working processes could be substituted to perform the same function.

In the claims which follow and in the preceding description of the invention, except where the context requires otherwise due to express language or necessary implication, the word “comprise” or variations such as “comprises” or “comprising” is used in an inclusive sense, i.e. to specify the presence of the stated features but not to preclude the presence or addition of further features in various embodiments of the invention.

1. A trailable vehicle comprising a body for defining an interior space of the trailable vehicle, the body having at least one side wall extending between a roof and base of the trailable vehicle; wherein at least part of one side wall is directly connected to the roof and substantially formed of metallic sheet material.

2. The trailable vehicle according to claim 1, wherein the body has two or more side walls which are connected to peripheral edges of the roof.

3. The trailable vehicle according to claim 2, wherein at least one side wall is directly connected to the base.

4. The trailable vehicle according to claim 3, wherein adjoining peripheral edges of the side walls and roof are further connected to form a weather-resistant trailable vehicle body.

5. The trailable vehicle according to claim 3, wherein the body includes a reinforcing means.

6. A method of manufacturing a body of a trailable vehicle comprising at least one side wall extending from a roof and base of the trailable vehicle, the body being substantially formed from metallic sheet material, the method including: pressing the sheet material to form at least part of one side wall and roof; and directly connecting the side wall to a peripheral edge of the roof such that the side wall extends downwardly from the peripheral edge of the roof.

7. The method according to claim 6, wherein the step of pressing the sheet material comprises pressing the sheet material to form a body having a roof flanked by a pair of downwardly extending side walls.

8. The method according to claim 6, wherein the side walls and roof are directly connected at their adjoining peripheral edges, and to the base to form a weather-resistant trailable vehicle body.

9. The method according to claim 6, further comprising the step of reinforcing the interior surface of the body.

10. The method according to claim 6, including a step of coating the side walls and roof with an anti-corrosive coating.

11. A trailable vehicle stabilising system for stabilising a trailable vehicle during travel, the system comprising at least one wing member being mountable to a body of the trailable vehicle wherein the wing member(s) or the wing members are configured to generate a downward force on the trailable vehicle during travel.

12. The stabilising system according to claim 11, wherein the wing member or the wing members are mountable to a front wall which faces oncoming airflow during travel and/or an oppositely facing rear wall of the trailable vehicle.

13. The stabilising system according to claim 11, wherein one of the at least one wing member is mounted to the front wall and extends in a direction substantially opposite to that of the oncoming airflow, the wing member being configured to guide the oncoming airflow which is opposite to the direction of travel to increase downward force at a front of the trailable vehicle.

14. The stabilising system according to claim 13, wherein the wing member has an upper surface and a lower surface, wherein the upper surface is configured to guide the oncoming airflow at an upper portion of the front wall over a roof of the trailable vehicle.

15. The stabilising system according to claim 11, wherein the at least one wing member is mounted to the rear wall and extends substantially in the direction of the oncoming airflow, the wing member being configured to guide the oncoming airflow to increase downward force at the rear of the trailable vehicle.

16. The stabilising system having the wing member according to claim 12.

17. The stabilising system according to claim 16, wherein the or each wing member is integral to the body of the trailable vehicle.

18. The stabilising system according to claim 17, wherein the system comprises at least one diffusing element mountable to the body of the trailable vehicle for reduction of turbulent air flow and/or drag forces.

19. The trailable vehicle having the stabilising system according to claim 11.

20. The stabilising system according to claim 11, wherein the wing member or the wing members are configured to increase the front ball weight of the trailable vehicle during travel.
